(19) United States
(12) Patent Application Publication
(10) Pub. No.: US 2025/0349984 A1
(43) Pub. Date: Nov. 13, 2025

(54) Power Storage Module and Power Storage Device

(71) Applicant: TOYOTA JIDOSHA KABUSHIKI KAISHA, Toyota-shi Aichi-ken (JP)

(72) Inventors: Shinya ISHIKAWA, Anjo-shi (JP); Yusuke KINTSU, Miyoshi-shi (JP); Takumi TANAKA, Toyota-shi Aichi-ken (JP); Masayoshi HAGA, Nagoya-shi Aichi-ken (JP); Kazuki MURAISHI, Toyota-shi Aichi-ken (JP); Yuji YAMASHITA, Toyota-shi Aichi-ken (JP); Aya SATO, Nagoya-shi Aichi-ken (JP)

(73) Assignee: TOYOTA JIDOSHA KABUSHIKI KAISHA, Toyota-shi Aichi-ken (JP)

(21) Appl. No.: 19/198,173

(22) Filed: May 5, 2025

(30) Foreign Application Priority Data
May 13, 2024 (JP) 2024-077866

(51) Int. Cl. H01M 50/507; B60L 50/64; H01M 50/209; H01M 50/516; H01M 50/567

(52) U.S. Cl. CPC H01M 50/507; H01M 50/209; H01M 50/516; H01M 50/567; B60L 50/64; H01M 2220/20

(57) ABSTRACT

A power storage module comprises a plurality of cells and a bus bar. Each of the cells includes a prismatic case, an electrode terminal, and a power generation element. An outer surface of the prismatic case includes a wide face having a rectangular shape and a side face. The cells are stacked together. The electrode terminal protrudes from the side face toward an outside of the prismatic case. The electrode terminal includes an upper end portion and a lower end portion. The lower end portion is positioned inside the prismatic case. The upper end portion is positioned outside the prismatic case. The bus bar is connected to the electrode terminal at a position in the long-side direction between the upper end portion of the electrode terminal and the side face of the prismatic case.

### CROSS REFERENCE TO RELATED APPLICATIONS

This nonprovisional application is based on Japanese Patent Application No. 2024-077866 filed on May 13, 2024, with the Japan Patent Office, the entire contents of which are hereby incorporated by reference.

### BACKGROUND OF THE DISCLOSURE

### Field of the Disclosure

The present disclosure relates to a power storage module and a power storage device.

### Description of the Background Art

Japanese Patent Laying-Open No. 2018-106800 discloses a power storage module formed by stacking a plurality of cells.

### SUMMARY

A power storage device (also called “a battery pack”) includes a housing and a power storage module. The housing accommodates the power storage module. The power storage module may include a plurality of cells and a bus bar. The bus bar connects together electrode terminals of two or more of the cells. Conventionally, the bus bar connects in such a manner to cover the upper end portions of the electrode terminals. That is, the bus bar protrudes outwardly from the cell case, beyond the electrode terminals. Due to the bus bar thus protruding outwardly, accommodation efficiency of the power storage module inside the housing can be degraded. Especially when the cell case is a prismatic case having a wide face and also when the electrode terminals protrude in the long-side direction of the wide face, accommodation efficiency of the power storage module inside the housing can be markedly degraded.

An object of the present disclosure is to improve the accommodation efficiency of a power storage module.

Hereinafter, the technical configuration and effects of the present disclosure will be described. It should be noted that the action mechanism includes presumption. The action mechanism does not limit the technical scope of the present disclosure.

1. A power storage module comprises a plurality of cells and a bus bar. Each of the cells includes a prismatic case, an electrode terminal, and a power generation element. The prismatic case is hexahedral. An outer surface of the prismatic case includes a wide face having a rectangular shape and a side face. The side face crosses a long-side direction of the wide face. The side face is connected to an end portion of the wide face in the long-side direction. The prismatic case accommodates the power generation element. The cells are stacked together in such a manner that the wide faces of an adjacent pair of the cells face to each other. The electrode terminal protrudes from the side face toward an outside of the prismatic case along the long-side direction of the wide face. The electrode terminal includes an upper end portion and a lower end portion. The lower end portion is positioned inside the prismatic case. The upper end portion is positioned outside the prismatic case. The bus bar connects together the electrode terminals of the cells adjacent to each other. The bus bar is connected to the electrode terminal at a position in the long-side direction between the upper end portion of the electrode terminal and the side face of the prismatic case.

In the power storage module according to “1” above, in the long-side direction (the width direction) of the wide face, the bus bar does not protrude outwardly beyond the electrode terminal. Therefore, the accommodation efficiency of the power storage module is expected to be improved.

2. The power storage module according to “1” above may include the following configuration, for example. The electrode terminal has a small-diameter portion. A diameter of the small-diameter portion is smaller than a diameter of the upper end portion. In the long-side direction, the small-diameter portion is positioned between the upper end portion and the side face. The bus bar is engaged with the small-diameter portion.

With the bus bar thus engaged with the small-diameter portion of the electrode terminal, connection between the electrode terminal and the bus bar is expected to be stable, for example.

3. The power storage module according to above “2” may include the following configuration, for example. The upper end portion of the electrode terminal has a flange portion extending outwardly in a radial direction of the electrode terminal beyond the small-diameter portion. The flange portion is welded to the bus bar.

For example, the flange portion of the electrode terminal may be irradiated with a laser for welding the upper end portion to the bus bar.

4. The power storage module according to any one of “1” to “3” above may include the following configuration, for example. The electrode terminal includes a first component and a second component. The first component has a shape of a cap having a recess. The first component is engaged with the second component.

With the electrode terminal being composed of two components, the area of joining between the electrode terminal and the bus bar can be increased.

5. The power storage module according to any one of “1” to “3” above may include the following configuration, for example. The electrode terminal includes a first component and a second component. The first component is joined to the second component by a screw mechanism.

For example, the bus bar may be interposed between the two components. For example, the load applied to the bus bar may be regulated by threadedly engaging the two components with each other.

6. The power storage module according to any one of “1” to “5” above may include the following configuration, for example. The power storage module further includes a ring-shaped component. The ring-shaped component is electrically insulating. The electrode terminal is inserted in the ring-shaped component. The bus bar is connected to a position between the upper end portion of the electrode terminal and the ring-shaped component.

When the bus bar is positioned on an inner side with respect to the upper end portion of the electrode terminal, there is a possibility that the bus bar can come into contact with the prismatic case. When the bus bar comes into contact with the prismatic case, a short circuit can occur. For avoiding a short circuit, an electrically insulating ring-shaped component (a spacer) may be placed between the bus bar and the prismatic case.

7. A power storage device includes the power storage module according to any one of “1” to “6” above, a housing, and an electrically insulating component. The housing accommodates the power storage module and the electrically insulating component. The upper end portion of the electrode terminal faces an inner surface of the housing. The electrically insulating component is positioned between the upper end portion and the inner surface.

When the bus bar is positioned on an inner side with respect to the upper end portion (the electrode terminal), it means that the upper end portion protrudes toward the inner surface of the housing. When the housing is made of metal, a contact between the upper end portion and the inner surface of the housing can cause a short circuit. For avoiding a short circuit, an electrically insulating component may be positioned between the upper end portion and the housing.

In the following, an embodiment of the present disclosure (which may also be simply called “the present embodiment” hereinafter) will be described. It should be noted that the present embodiment does not limit the technical scope of the present disclosure. The present embodiment is illustrative in any respect. The present embodiment is non-restrictive. The technical scope of the present disclosure encompasses any modifications within the meaning and the scope equivalent to the terms of the claims. For example, it is originally planned that any configurations of the present embodiment may be optionally combined.

### BRIEF DESCRIPTION OF THE DRAWINGS

FIG. 1 is a conceptual view illustrating an example of a vehicle according to the present embodiment.

FIG. 2 is a schematic perspective view illustrating an example of a power storage device according to the present embodiment.

FIG. 3 is a side view illustrating an example of a power storage module according to the present embodiment.

FIG. 4 is a schematic view illustrating an example of a cell according to the present embodiment.

FIG. 5 is a first schematic cross-sectional view illustrating an electrode terminal according to the present embodiment.

FIG. 6 is a second schematic cross-sectional view illustrating an electrode terminal according to the present embodiment.

FIG. 7 is a first schematic plan view illustrating an example of a bus bar according to the present embodiment.

FIG. 8 is a second schematic plan view illustrating an example of a bus bar according to the present embodiment.

FIG. 9 is a third schematic plan view illustrating an example of a bus bar according to the present embodiment.

FIG. 10 is a third schematic cross-sectional view illustrating an electrode terminal according to the present embodiment.

FIG. 11 is a fourth schematic cross-sectional view illustrating an electrode terminal according to the present embodiment.

### DESCRIPTION OF THE EMBODIMENTS

### Terms and Phrases

Terms such as “comprise”, “include”, and “have”, and other similar terms are open-ended terms. In an open-ended term, in addition to a stated component, an additional component may or may not be further included. The term “consist of” is a closed-end term. However, even in a configuration that is expressed by a closed-end term, impurities present under ordinary circumstances as well as an additional element irrelevant to the technique of interest may be included. The term “consist essentially of” is a semiclosed-end term. A semiclosed-end term tolerates addition of an element that does not substantially affect the fundamental, novel features of the technique of interest.

Expressions such as “may” and “can” are not intended to mean “must” (obligation) but rather mean “there is a possibility” (tolerance).

Any geometric term should not be interpreted solely in its exact meaning. Examples of geometric terms include “parallel”, “vertical”, “orthogonal”, and the like. For example, as long as substantially the same or similar functions are obtained, the relative direction, angle, distance, and the like may vary. Any geometric term herein may include tolerances and/or errors in terms of design, operation, production, and/or the like. The dimensional relationship in each figure may not necessarily coincide with the actual dimensional relationship. For the purpose of assisting understanding for the readers, the dimensional relationship in each figure may have been changed. For example, length, width, thickness, and the like may have been changed. A part of a given configuration may have been omitted.

A singular form may also include its plural meaning, unless otherwise specified. For example, “a cell” may mean a plurality of cells (a group of cells).

“Cell” refers to a single cell. A cell may be a lithium-ion battery, for example. A cell may include a liquid electrolyte (an electrolyte solution), a gelled electrolyte, or a solid electrolyte, for example.

“Electrode” collectively refers to a positive electrode and a negative electrode. For example, “electrode terminal” collectively refers to a positive electrode terminal and a negative electrode terminal.

In the present embodiment, a power storage module and a power storage device “for vehicle applications” will be described. However, vehicle applications are merely an example of the purpose of use. The purpose of use is not particularly limited.

In the drawings, the thickness direction (the T direction), the width direction (the W direction), and the height direction (the H direction) agree with the T direction, the W direction, and the H direction of the cell, respectively. These three directions are orthogonal to each other. For example, the T direction may or may not be parallel to the direction of travel of the vehicle. For example, the T direction may be orthogonal to the direction of travel of the vehicle.

### Vehicle

FIG. 1 is a conceptual view illustrating an example of a vehicle according to the present embodiment. A vehicle 1 may be a BEV (Battery Electric Vehicle), an HEV (Hybrid Electric Vehicle), a PHEV (Plug-in Hybrid Electric Vehicle), or the like, for example. Vehicle 1 includes a power storage device 10. The position to mount the power storage device 10 is not particularly limited. For example, power storage device 10 may be placed under the floor of vehicle 1.

### Power Storage Device

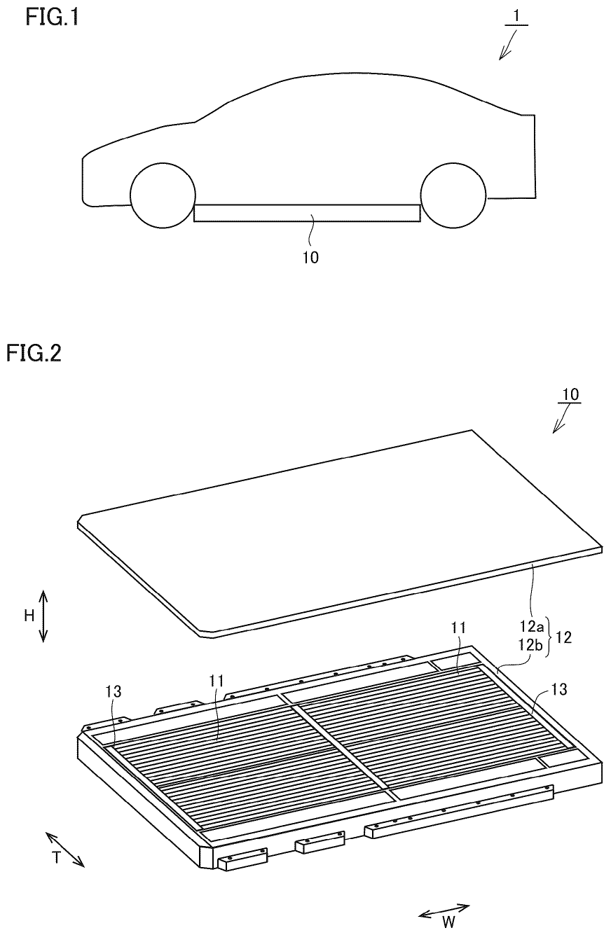

FIG. 2 is a schematic perspective view illustrating an example of a power storage device according to the present embodiment. Power storage device 10 includes a power storage module 11, a housing 12, and an electrically insulating component 13. Power storage device 10 may include a plurality of power storage modules 11. For example, power storage device 10 may include two or more, or four or more, or six or more power storage modules 11. For example, power storage device 10 may include eight or less, or six or less, or four or less power storage modules 11.

Housing 12 accommodates power storage module 11 and electrically insulating component 13. Housing 12 may be made of metal, for example. Housing 12 may include an upper case 12a and a lower case 12b, for example. There may be a gap between power storage modules 11. For example, a divider (not illustrated) may be provided between power storage modules 11.

Power storage device 10 may further include a cooler (not illustrated). The cooler is capable of cooling power storage module 11. The cooler may include a coolant flow path and/or the like, for example. The cooler may be interposed between upper case 12a and power storage module 11, for example. The cooler may be interposed between lower case 12b and power storage module 11, for example. Inside the housing 12, electrically insulating component 13 is interposed between power storage module 11 and an inner surface of housing 12.

### Power Storage Module

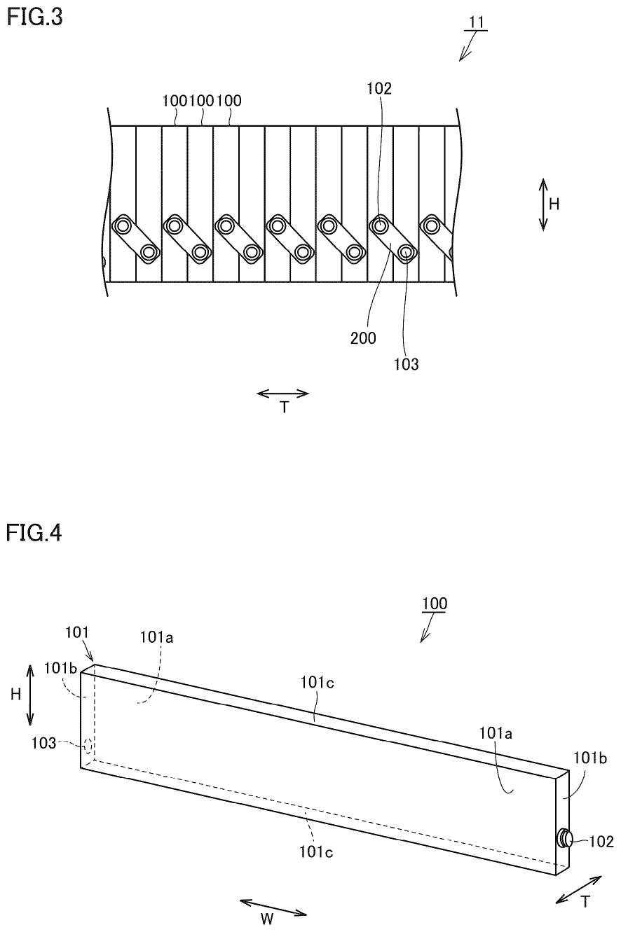

FIG. 3 is a side view illustrating an example of a power storage module according to the present embodiment. The side view according to the present embodiment is a view that is viewed in the W direction. Power storage module 11 includes a plurality of cells 100 and a bus bar 200. The number of cells 100 may be 2 or more, or 4 or more, or 10 or more, or 20 or more, or 50 or more, or 100 or more, for example. The number of cells 100 may be 100 or less, or 50 or less, or 20 or less, or 10 or less, or 4 or less, for example.

The cells 100 are stacked together in the T direction. The cells 100 are stacked together in such a manner that wide faces 101a of an adjacent pair of cells 100 face to each other. A pair of cells 100 adjacent to each other are oriented oppositely in the W direction, and, thereby, a positive electrode terminal 102 of one cell 100 is adjacent to a negative electrode terminal 103 of the other cell 100.

Bus bar 200 is electrically conductive. Bus bar 200 may be made of metal, for example. Bus bar 200 may include aluminum (Al), copper (Cu), and/or the like, for example. Bus bar 200 connects together the electrode terminals of cells 100. Bus bar 200 may connect positive electrode terminal 102 with negative electrode terminal 103, for example. Bus bar 200 may connect positive electrode terminal 102 with positive electrode terminal 102, for example. Bus bar 200 may connect negative electrode terminal 103 with negative electrode terminal 103, for example. Bus bar 200 may be joined to the electrode terminal. For example, bus bar 200 may be joined to the electrode terminal by resistance welding, ultrasonic joining, laser welding, and/or the like.

As illustrated in FIG. 3, bus bar 200 may be inclined in the H direction, for example. Bus bar 200 may extend parallel to the T direction, for example.

FIG. 4 is a schematic view illustrating an example of a cell according to the present embodiment. Each of the cells 100 includes a prismatic case 101, positive electrode terminal 102, negative electrode terminal 103, and a power generation element 300. Prismatic case 101 accommodates power generation element 300. Power generation element 300 is also called “an electrode assembly”. Power generation element 300 may include a positive electrode, a negative electrode, a separator, and an electrolyte, for example. Power generation element 300 may be either a stack-type one or a wound-type one, for example. Each of the positive electrode and the negative electrode may be in sheet form. The positive electrode may include lithium iron phosphate, lithium-nickel composite oxide, and/or the like, for example. The negative electrode may include graphite, silicon oxide, silicon, and/or the like.

Prismatic case 101 may be made of metal, for example. Prismatic case 101 may include Al and/or the like, for example. Prismatic case 101 may have a flat-plate like outer shape. Prismatic case 101 may be in the shape of a long plate, for example.

The width of prismatic case 101 refers to the outer dimension in the W direction. The width of prismatic case 101 may be 500 mm or more, or 750 mm or more, or 1000 mm or more, for example. The width of prismatic case 101 may be 2000 mm or less, or 1500 mm or less, or 1250 mm or less, for example. The height of prismatic case 101 refers to the outer dimension in the H direction. The height of prismatic case 101 may be 50 mm or more, or 75 mm or more, or 100 mm or more, for example. The height of prismatic case 101 may be 200 mm or less, or 150 mm or less, or 125 mm or less, or 100 mm or less, for example. The thickness of prismatic case 101 refers to the outer dimension in the T direction. The thickness of prismatic case 101 may be 5 mm or more, or 10 mm or more, or 15 mm or more, or 20 mm or more, for example. The thickness of prismatic case 101 may be 30 mm or less, or 25 mm or less, or 20 mm or less, or 15 mm or less, or 10 mm or less, for example.

The ratio of width to height (which may also be called “a first aspect ratio”) may be from 5 to 20, for example. The ratio of width to thickness (which may also be called “a second aspect ratio”) may be from 50 to 200, for example.

Prismatic case 101 is hexahedral. In other words, prismatic case 101 includes six faces. Each face may be either flat or curved. The outer surface of prismatic case 101 includes a pair of wide faces 101a, a pair of side faces 101b, and a pair of bottom faces 101c. The faces of each pair may have the same shape, or may have different shapes. The portion (the edge) at which a face is connected to another face may be either angular or rounded.

Wide faces 101a are rectangular. Wide faces 101a have the largest area among the six faces. Each wide face 101a has a long-side direction and a short-side direction. In FIG. 4, the long-side direction is the W direction. The short-side direction is the H direction. Wide face 101a extends in the long-side direction. Side face 101b crosses the long-side direction. Side face 101b may be orthogonal to the long-side direction. Side face 101b is connected to an end portion of wide face 101a in the long-side direction. Bottom face 101c crosses the short-side direction. Bottom face 101c may be orthogonal to the short-side direction. Bottom face 101c is connected to an end portion of wide face 101a in the short-side direction.

Positive electrode terminal 102 passes through side face 101b. Inside the prismatic case 101, positive electrode terminal 102 is electrically connected to the positive electrode (power generation element 300). Positive electrode terminal 102 protrudes from side face 101b toward the outside of prismatic case 101 along the long-side direction (the W direction). “The direction along the long-side direction” includes all the directions except for the short-side direction (which is orthogonal to the long-side direction). For example, the direction along the long-side direction may be parallel to the long-side direction.

Negative electrode terminal 103 passes through side face 101b. Inside the prismatic case 101, negative electrode terminal 103 is electrically connected to the negative electrode (power generation element 300). In FIG. 4, negative electrode terminal 103 and positive electrode terminal 102 protrude in opposite directions. In an embodiment, negative electrode terminal 103 and positive electrode terminal 102 may protrude in the same direction. That is, both the positive electrode terminal 102 and the negative electrode terminal 103 may be positioned on the same side face 101b.

In FIG. 4, in the H direction, the position of negative electrode terminal 103 is different from the position of positive electrode terminal 102. In the H direction, the position of negative electrode terminal 103 may be the same as the position of positive electrode terminal 102.

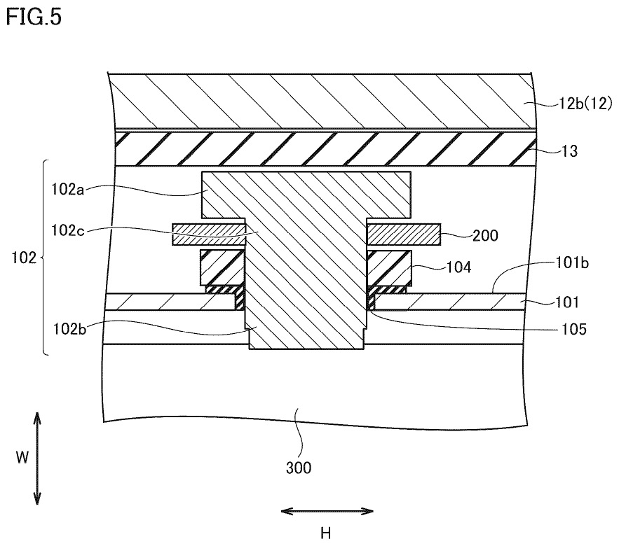

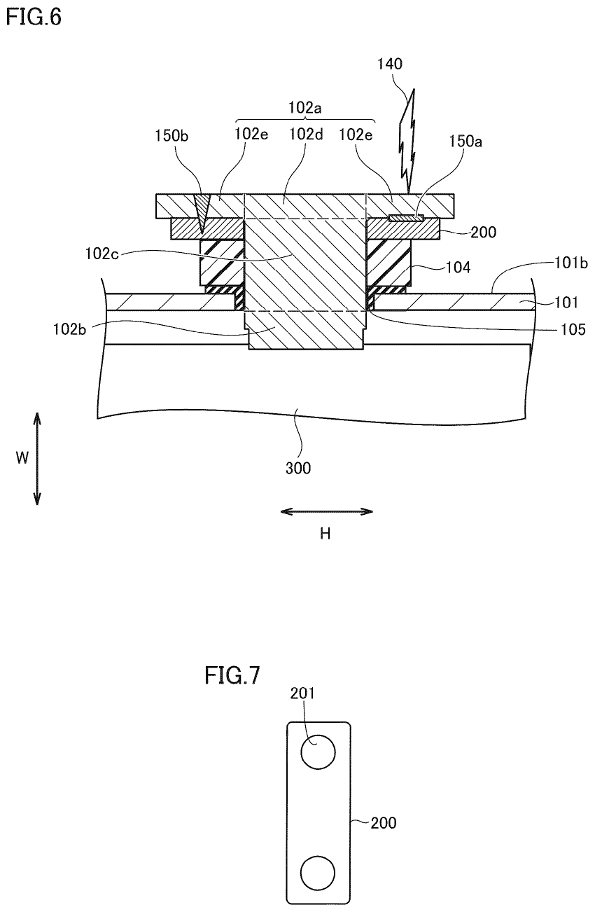

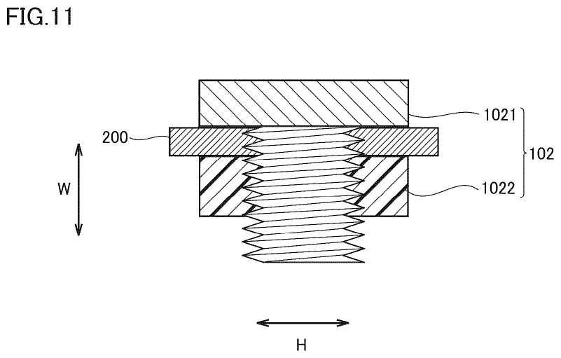

FIG. 5 is a first schematic cross-sectional view illustrating an electrode terminal according to the present embodiment. In FIG. 5, FIG. 6, FIG. 10, and FIG. 11, positive electrode terminal 102 is illustrated. Negative electrode terminal 103 (not illustrated) may have the same structure as that of positive electrode terminal 102.

Positive electrode terminal 102 includes an upper end portion 102a and a lower end portion 102b. Lower end portion 102b is positioned inside the prismatic case 101. Lower end portion 102b is connected to power generation element 300. Upper end portion 102a is positioned outside the prismatic case 101. Upper end portion 102a includes an end face of positive electrode terminal 102. The end face of positive electrode terminal 102 may be either flat or curved. Bus bar 200 is connected to positive electrode terminal 102 at a position in the long-side direction (the W direction) between upper end portion 102a of positive electrode terminal 102 and side face 101b of prismatic case 101.

Positive electrode terminal 102 may have a small-diameter portion 102c. In the long-side direction (the W direction), small-diameter portion 102c is positioned between upper end portion 102a and side face 101b. The diameter of small-diameter portion 102c is smaller than the diameter of upper end portion 102a. Bus bar 200 may be engaged with small-diameter portion 102c. The diameter of small-diameter portion 102c may be uniform. The diameter of small-diameter portion 102c may vary in the axial direction of positive electrode terminal 102. For example, small-diameter portion 102c may be tapered or inversely tapered in the direction from lower end portion 102b toward upper end portion 102a.

The ratio of the diameter of small-diameter portion 102c to the diameter of upper end portion 102a may be 0.9 or less, or 0.8 or less, or 0.7 or less, or 0.6 or less, or 0.5 or less, for example. The ratio of the diameter of small-diameter portion 102c to the diameter of upper end portion 102a may be 0.1 or more, or 0.2 or more, or 0.3 or more, or 0.4 or more, or 0.5 or more, for example. In a cross section orthogonal to the axial direction of the electrode terminal, when the contour of upper end portion 102a and the contour of small-diameter portion 102c are not circular, their diameters are regarded as their largest diameters, respectively.

The diameter of lower end portion 102b is not particularly limited. For example, the diameter of lower end portion 102b may be the same as the diameter of small-diameter portion 102c. For example, the diameter of lower end portion 102b may be either greater or smaller than the diameter of small-diameter portion 102c.

FIG. 6 is a second schematic cross-sectional view illustrating an electrode terminal according to the present embodiment. For example, upper end portion 102a of positive electrode terminal 102 may have a stem portion 102d and a flange portion 102e. Stem portion 102d includes the central axis of positive electrode terminal 102. Flange portion 102e extends outwardly in the radial direction of positive electrode terminal 102 beyond small-diameter portion 102c. In FIG. 6, the radial direction is the H direction. Flange portion 102e may be formed for the entire circumference of positive electrode terminal 102, for example. Flange portion 102e may extend to cover bus bar 200, for example. Flange portion 102e may be welded to bus bar 200. For example, flange portion 102e may be joined to bus bar 200 by penetration welding. For example, flange portion 102e may be welded to bus bar 200 by irradiation of the upper face of flange portion 102e with a laser 140. For example, flange portion 102e and bus bar 200 may be joined to each other by keyhole welding.

Between flange portion 102e and bus bar 200, a welded portion may be formed. For example, a first welded portion 150a may be formed extending in layer form along the interface between flange portion 102e and bus bar 200. For example, a second welded portion 150b may be formed extending along the depth direction of flange portion 102e and bus bar 200. For example, the welded portion may include a constituent metal of flange portion 102e and a constituent metal of bus bar 200. For example, the welded portion may include an alloy made of a constituent metal of flange portion 102e and a constituent metal of bus bar 200. The welded portion may include at least one selected from the group consisting of Al, Cu, and Al—Cu alloy. The thickness of flange portion 102e may be from 0.2 to 5 mm, or from 0.2 to 2 mm, for example. Flange portion 102e may be either thinner or thicker than bus bar 200.

FIG. 7 is a first schematic plan view illustrating an example of a bus bar according to the present embodiment. Bus bar 200 may be in plate form, for example. Bus bar 200 may have two through holes 201. In through holes 201, the electrode terminals may be inserted.

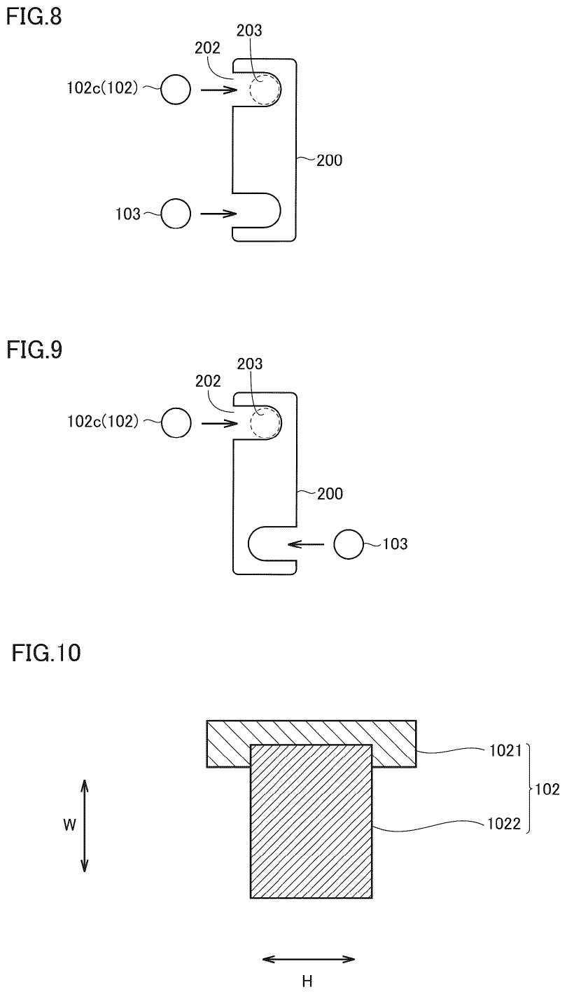

FIG. 8 is a second schematic plan view illustrating an example of a bus bar according to the present embodiment. Bus bar 200 may have an open portion 202. For example, small-diameter portion 102c may be slid into the open portion 202 to reach a fixation position 203. In other words, bus bar 200 may be engaged with small-diameter portion 102c. Similarly to positive electrode terminal 102, the small-diameter portion of negative electrode terminal 103 may be slid into the open portion 202 to reach fixation position 203.

FIG. 9 is a third schematic plan view illustrating an example of a bus bar according to the present embodiment. For example, two open portions 202 may be positioned alternately with respect to the axis of bus bar 200.

As illustrated in FIG. 5, power storage module 11 may further include a ring-shaped component 104 (a spacer). Ring-shaped component 104 is electrically insulating. Ring-shaped component 104 may be made of resin, ceramic, and/or the like, for example. Positive electrode terminal 102 is inserted in ring-shaped component 104. Bus bar 200 is connected to a position between upper end portion 102a and ring-shaped component 104.

Power storage module 11 may further include a sealing material 105. Sealing material 105 seals the interstice between positive electrode terminal 102 and prismatic case 101. Sealing material 105 may be in ring form. Sealing material 105 may be electrically insulating. Sealing material 105 may be made of rubber, resin, and/or the like, for example. Sealing material 105 may be resistant to the electrolyte solution, for example.

Upper end portion 102a faces the inner surface of housing 12. Between upper end portion 102a and the inner surface of housing 12, electrically insulating component 13 may be placed. Electrically insulating component 13 may be in plate form, for example. Electrically insulating component 13 may be made of resin, ceramic, and/or the like, for example. Electrically insulating component 13 may fill the interstice between upper end portion 102a and the inner surface of housing 12. Electrically insulating component 13 may cover upper end portion 102a. Electrically insulating component 13 may be made to adhere to upper end portion 102a. Electrically insulating component 13 may be made to adhere to the inner surface of housing 12.

Electrically insulating component 13 may include a heat-dissipating material, for example. Electrically insulating component 13 may include a heat-insulating material, for example. Electrically insulating component 13 may have cushioning properties, for example. Electrically insulating component 13 may function as a shock-absorbing material. Electrically insulating component 13 may be a porous material, for example.

FIG. 10 is a third schematic cross-sectional view illustrating an electrode terminal according to the present embodiment. In an embodiment, positive electrode terminal 102 may include a first component 1021 and a second component 1022. First component 1021 includes upper end portion 102a. First component 1021 has a shape of a cap having a recess. Second component 1022 may be columnar, for example. First component 1021 may be engaged with second component 1022. For example, second component 1022 may be pressed into the recess of first component 1021 to make first component 1021 and second component 1022 engaged with each other.

FIG. 11 is a fourth schematic cross-sectional view illustrating an electrode terminal according to the present embodiment. In an embodiment, positive electrode terminal 102 may include first component 1021 and second component 1022. First component 1021 may have an external thread portion, for example. First component 1021 is electrically conductive. Second component 1022 may have an internal thread portion, for example. Second component 1022 may be electrically insulating. First component 1021 may be joined to second component 1022 by a screw mechanism. In other words, first component 1021 may be threadedly engaged with second component 1022.

For example, bus bar 200 may also have an internal thread portion. Positive electrode terminal 102 may be joined to bus bar 200 by a screw mechanism. In other words, first component 1021 may be threadedly engaged with bus bar 200. Bus bar 200 may be held between first component 1021 and second component 1022.

What is claimed is:

1. A power storage module comprising:
a plurality of cells; and
a bus bar, wherein
each of the cells includes a prismatic case, an electrode terminal, and a power generation element,
the prismatic case is hexahedral,
an outer surface of the prismatic case includes a wide face having a rectangular shape and a side face,
the side face crosses a long-side direction of the wide face,
the side face is connected to an end portion of the wide face in the long-side direction,
the prismatic case accommodates the power generation element,
the cells are stacked together in such a manner that the wide faces of an adjacent pair of the cells face to each other,
the electrode terminal protrudes from the side face toward an outside of the prismatic case along the long-side direction of the wide face,
the electrode terminal includes an upper end portion and a lower end portion,
the lower end portion is positioned inside the prismatic case,
the upper end portion is positioned outside the prismatic case,
the bus bar connects together the electrode terminals of the cells adjacent to each other, and
the bus bar is connected to the electrode terminal at a position in the long-side direction between the upper end portion of the electrode terminal and the side face of the prismatic case.

2. The power storage module according to claim 1, wherein
the electrode terminal has a small-diameter portion,
a diameter of the small-diameter portion is smaller than a diameter of the upper end portion,
in the long-side direction, the small-diameter portion is positioned between the upper end portion and the side face, and
the bus bar is engaged with the small-diameter portion.

3. The power storage module according to claim 2, wherein
the upper end portion of the electrode terminal has a flange portion extending outwardly in a radial direction of the electrode terminal beyond the small-diameter portion, and
the flange portion is welded to the bus bar.

4. The power storage module according to claim 1, wherein
the electrode terminal includes a first component and a second component,
the first component has a shape of a cap having a recess, and
the first component is engaged with the second component.

5. The power storage module according to claim 1, wherein
the electrode terminal includes a first component and a second component, and
the first component is joined to the second component by a screw mechanism.

6. The power storage module according to claim 1, wherein
the power storage module further includes a ring-shaped component,
the ring-shaped component is electrically insulating,
the electrode terminal is inserted in the ring-shaped component, and
the bus bar is connected to a position between the upper end portion of the electrode terminal and the ring-shaped component.

7. A power storage device comprising:
the power storage module according to claim 1;
a housing; and
an electrically insulating component, wherein
the housing accommodates the power storage module and the electrically insulating component,
the upper end portion of the electrode terminal faces an inner surface of the housing, and
the electrically insulating component is positioned between the upper end portion and the inner surface.
